(19) United States
(12) Patent Application Publication
(10) Pub. No.: US 2010/0290754 A1
(43) Pub. Date: Nov. 18, 2010

(54) DEVICE AND METHOD FOR HOLDING OPTICAL FIBER CORD, AND OPTICAL FIBER CONNECTING APPARATUS

(76) Inventor: Takaya Yamauchi, Sagamihara (JP)

Correspondence Address: 3M INNOVATIVE PROPERTIES COMPANY, PO BOX 33427, ST. PAUL, MN, 55133-3427, US

(21) Appl. No.: 12/812,267

(22) PCT Filed: Jan. 16, 2009
(86) PCT No.: PCT/US09/31178

§ 371 Date: Jul. 9, 2010

(30) Foreign Application Priority Data
Feb. 4, 2008 (JP) 2008-023896

(51) Int. Cl. G02B 6/36; B23Q 7/00

(52) U.S. Cl. 385/137; 29/559

(57) ABSTRACT

A holding device 10 includes a supporting member 12 for supporting an optical fiber cord 1 and a fixing member 14 for fixing optical fiber cord 1 to supporting member 12. Supporting member 12 includes a hitching section 16 for hitching a jacket end 5 configured by turning back a tension member 3 exposed outside a jacket 4 onto an outer surface of jacket 4, in a manner as to prevent optical fiber cord 1 from falling off from supporting member 12 due to at least a weight of optical fiber cord 1. Fixing member 14 includes a pressing section 18 acting to deform hitching section 16 hitching jacket end 5 by a pressing force to make hitching section 16 closely contact with jacket end 5. Pressing section 18 exerts pressing force dependently on a dimensional difference between hitching section 16 and pressing section 18, so as to compress hitching section 16.

### TECHNICAL FIELD

The present invention relates to a holding device and a holding method for holding an optical fiber cord. The present invention also relates to an optical fiber connecting apparatus including an optical fiber cord holding device.

### BACKGROUND ART

In the field of optical connection technology, various holding devices have been known for fixedly holding an optical fiber cord (also referred to as a jacketed optical cable) including a covered optical fiber and a tension member, both contained in a jacket.

For example, Japanese Unexamined Patent Publication (Kokai) No. 11-231171 discloses a supporting member used for an optical connector which terminates an optical fiber cord including an optical fiber and a reinforcing member, wherein the supporting member includes a press-fitting section that can be press-fitted to an end of the optical fiber cord and a reinforcing member holding section for holding the reinforcing member of the optical fiber cord. The supporting member abuts to a housing of the optical connector with the press-fitting section press-fitted to the end of the optical fiber cord and with the reinforcing member of the optical fiber cord held by the reinforcing member holding section. In such a state, the optical fiber is adhesively fixed to a ferrule, and the reinforcing member is placed on a reinforcing member fixation section provided on the housing. Then, a pressing sleeve as a separate member is disposed on the reinforcing member that has been placed on the reinforcing member fixation section, and the reinforcing member is fixed to the housing of the optical connector by pressing and calking the pressing sleeve from outside.

Also, Japanese Unexamined Patent Publication (Kokai) No. 2000-65271 discloses a terminal holder suitable in applications for connecting a jacket end of an optical fiber cord to an optical connector, wherein the terminal holder includes an optical connector having an inner tube that projects to the outside and a fastener having a bore that receives the tube. A convex portion is formed on the outer periphery at the end of the inner tube, and a concave portion is formed at the longitudinally intermediate portion. A convex portion is formed on the inner surface of the tube receiving hole on the fastener such that, upon attaching the fastener, it is placed directly on the concave portion of the inner tube. By inserting the inner tube into the inside of the jacket and the reinforcing fiber of the optical fiber cord, and by pressing the fastener into the outer side so as to sandwich the jacket and the reinforcing fiber between the inner tube and the fastener, the jacket end can be securely fixed to the optical connector.

### DISCLOSURE OF THE INVENTION

### Problems to be Solved by the Invention

In a holding device for an optical fiber cord or an optical fiber connecting apparatus including such a holding device, it is desired to eliminate the need of using a special dedicated tool, such as a calking tool, and also to reduce the number of parts in the device or apparatus.

It is an object of the present invention to provide a holding device for an optical fiber cord, which allows the number of parts to be reduced and permits an optical fiber cord to be easily held by a manual operation without using a dedicated special tool.

It is another object of the present invention to provide a holding method for an optical fiber cord, which allows the number of steps to be reduced and permits an optical fiber cord to be easily held by a manual operation without using a dedicated special tool.

It is a further object of the present invention to provide an optical fiber connecting apparatus including a holding device for an optical fiber cord, which allows the number of parts to be reduced and permits an optical fiber cord to be easily held by a manual operation without using a dedicated special tool, and which is therefore very suitable for an on-site or field assembling.

### Means for Solving the Problems

In order to accomplish the above object, one aspect of the present invention provides a holding device for fixedly holding an optical fiber cord including a covered optical fiber and a tension member, both contained in a jacket, characterized in that the holding device comprises a supporting member supporting the optical fiber cord; and a fixing member fixing the optical fiber cord relative to the supporting member; wherein the supporting member includes a hitching section hitching a jacket end configured by turning back an exposed tension member onto an outer surface of the jacket, in a manner as to prevent the optical fiber cord from falling off from the supporting member due to at least a weight of the optical fiber cord; and wherein the fixing member includes a pressing section acting to deform the hitching section hitching the jacket end by a pressing force to make the hitching section closely contact with the jacket end.

Another aspect of the present invention provides an optical fiber connecting apparatus comprising a holding device configured as described above.

A further aspect of the present invention provides a method for fixedly holding an optical fiber cord including a covered optical fiber and a tension member, both contained in a jacket, characterized in that the method comprises providing a supporting member supporting the optical fiber cord; providing a fixing member fixing the optical fiber cord relative to the supporting member; supporting and hitching a jacket end, configured by turning back an exposed tension member onto an outer surface of the jacket, on the supporting member, in a manner as to prevent the optical fiber cord from falling off from the supporting member due to at least a weight of the optical fiber cord; and engaging the fixing member with the supporting member supporting the jacket end and deforming the supporting member by a pressing force applied by the fixing member so as to make the supporting member closely contact with the jacket end.

### EFFECTS OF THE INVENTION

With the holding device according to one aspect of the present invention, the optical fiber cord can be fixedly held in two steps. That is, in the first step, the jacket end of the optical fiber cord is hitched by the hitching section of the supporting member, and in the second step, the hitching section having the jacket end hitched thereon is deformed by the pressing force exerted by the pressing section of the fixing member so as to bring the hitching section and the jacket end into close contact with each other. Since press-calking process is not employed in this holding operation, a dedicated special tool such as a calking tool is not required, and the number of parts can be reduced as compared to a conventional holding device employing the press-calking process. In the first step, in which the jacket end is hitched by the hitching section of the supporting member with holding strength as small as in a temporary holding, the operation can be manually accomplished with relatively weak force by an operator. In the second step, in which the pressing section of the fixing member engages with the outer surface of the hitching section of the supporting member and the flexible hitching section in tubular form is compressed toward the center, the operation can be accomplished as a relatively simple non-manual operation without requiring the force of an operator so as to securely fix the jacket end to the hitching section.

The optical fiber connecting apparatus according to the other aspect of the present invention allows the number of parts to be reduced and the optical fiber cord to be easily held by the holding device in manual operation without using a dedicated special tool such as a calking tool, and is therefore suitable for on-site assembly.

With the holding method for an optical fiber cord, according to the further aspect of the present invention, the number of process steps can be reduced, and the optical fiber cord can be easily held in manual operation without using a dedicated special tool such as a calking tool.

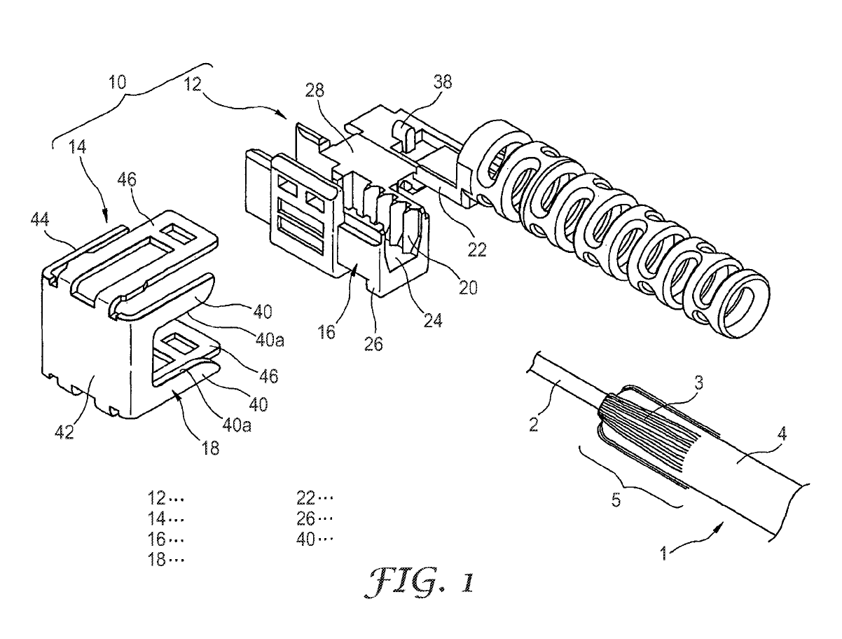

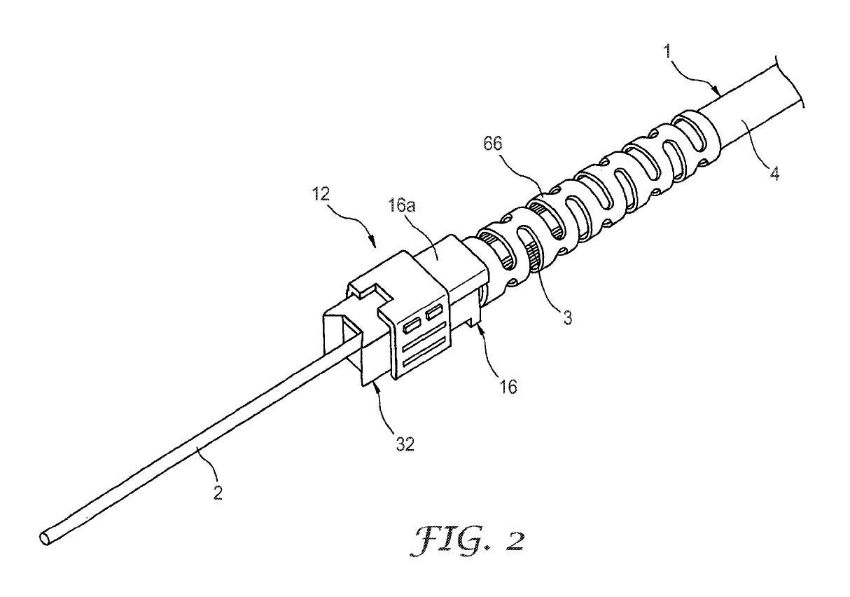

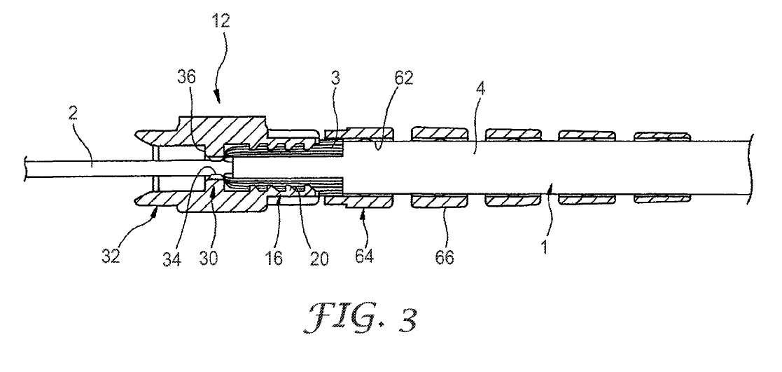

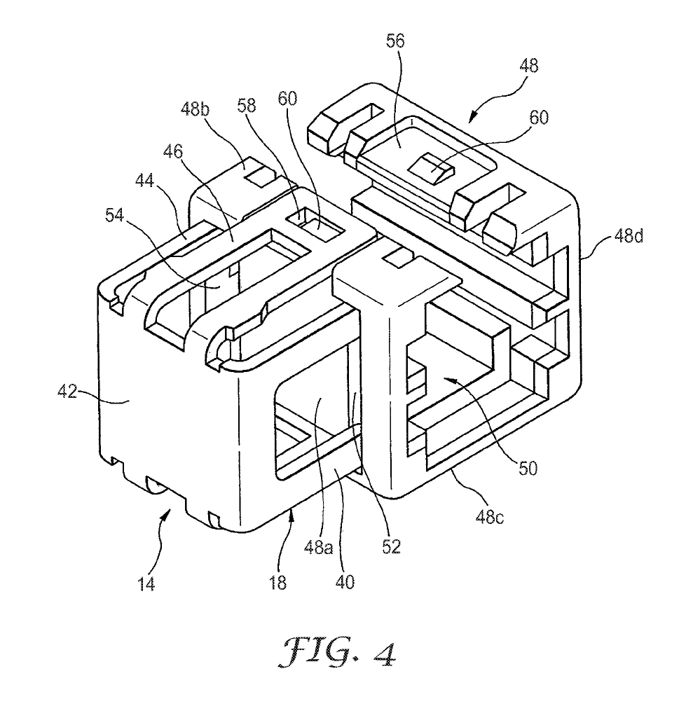

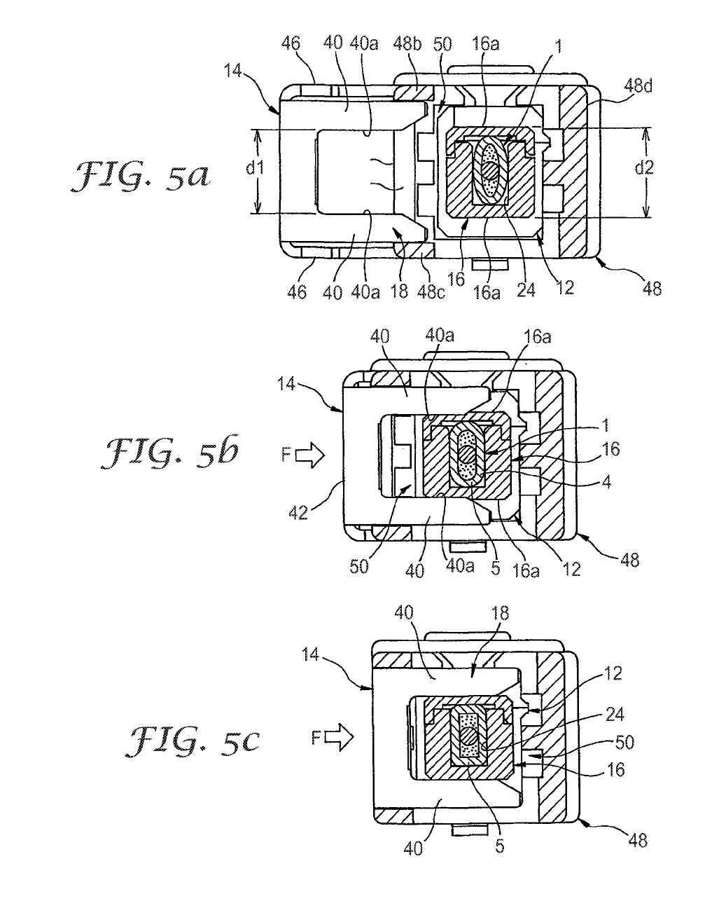

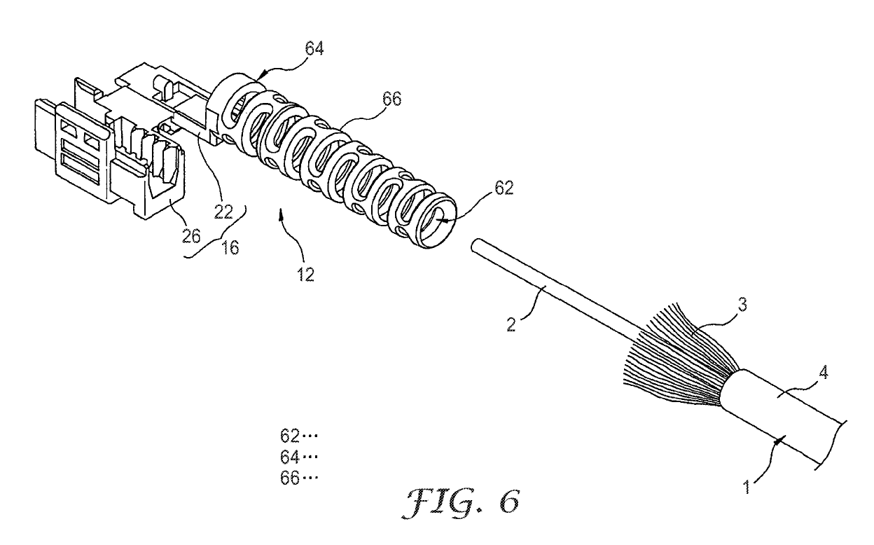

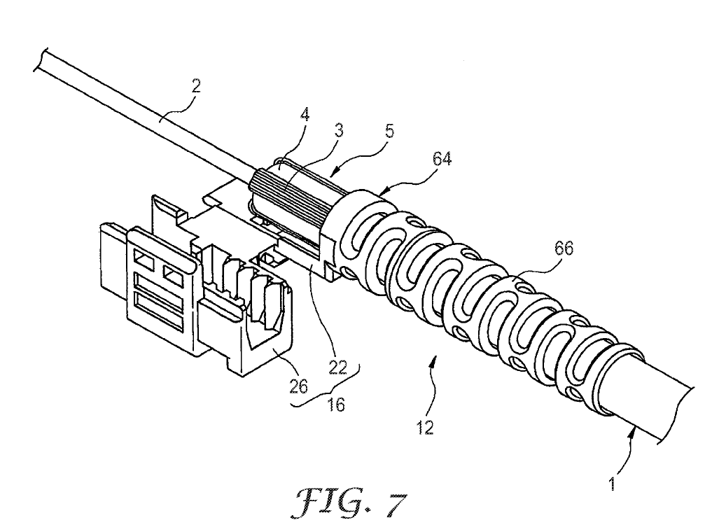

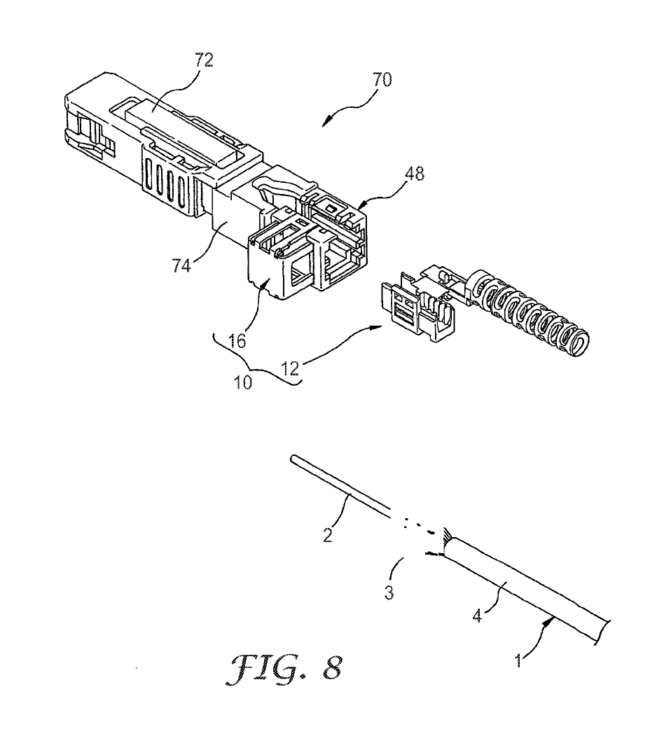

### BRIEF DESCRIPTION OF THE DRAWINGS

[FIG. 1] An exploded perspective view showing a holding device according to an embodiment of the present invention, together with a part of an optical fiber cord.

[FIG. 2] A perspective view showing a supporting member of the holding device of FIG. 1 with the optical fiber cord supported thereon.

[FIG. 3] A sectional view showing the supporting member of FIG. 2 with the optical fiber cord supported thereon.

[FIG. 4] An enlarged perspective view showing a fixing member and a housing of the holding device.

[FIG. 5] A sectional view explaining a holding process by using the holding device, and showing (a) the fixing member in a preparatory position, (b) the fixing member in motion, and (c) the fixing member in fully compressed position.

[FIG. 6] A perspective view showing the supporting member prior to attaching the optical fiber cord.

[FIG. 7] A perspective view showing the supporting member just before supporting the optical fiber cord arranged at a specified position.

[FIG. 8] An exploded perspective view showing an optical fiber connecting apparatus according to an embodiment of the present invention, together with the optical fiber cord.

### BEST MODE FOR CARRYING OUT THE INVENTION

Now, the present invention will be described in detail below with reference to appended drawings showing embodiments thereof. Throughout the drawings, corresponding components are denoted by common reference numerals.

FIG. 1 is a view showing a holding device 10 according to an embodiment of the present invention including an inset showing a portion of an optical fiber cord (also known as jacketed optical cable) 1. FIG. 2 is a view showing a supporting member 12 as a constituent of the holding device 10 with an optical fiber cord 1 held thereon. FIG. 3 is a sectional view showing the supporting member 12 with the optical fiber cord 1 held thereon. The holding device 10 fixedly holds a single core or multiple core (single core in the drawing) optical fiber cord 1, which consists of one or more covered optical fiber 2 and multiple tension resisting bodies (for example, aramide fiber) 3 contained in a flexible tubular jacket 4, on an object to be connected to (for example, an optical connector or the like) against an external force such as a tension.

The holding device 10 includes a supporting member 12 for supporting the optical fiber cord 1, and a fixing member 14 for fixing the optical fiber cord 1 to the supporting member 12. The supporting member 12 includes a hitching section 16 which hitches the jacket end 5 of the optical fiber cord 1 in the form in which the tension member 3 exposed to the outside of the jacket is folded back over the outer surface of the jacket 4 such that the optical fiber cord 1 can be prevented from dropping off from the supporting member 12 at least due to its own weight. The fixing member 14 includes a pressing section 18 which deforms the hitching section 16 hitching the jacket end 5 by the pressing force so as to bring the hitching section 16 and the jacket end 5 into close contact with each other.

When an optical fiber cord 1 is to be held by the holding device 10, as a preliminary step for connecting the optical fiber cord 1 to an object to be connected such as an optical connector, the jacket 4 is removed for a predetermined length in the distal end region of the optical fiber cord 1 so as to expose the covered optical fiber 2 and the tension member 3 to the outside of the jacket 4, and then the exposed portion of the tension member 3 is cut to a predetermined length. The jacket end 5 is formed by folding back the exposed portion of the tension member 3 over the outer surface of the jacket 4.

The hitching section 16 of the supporting member 12 has a tubular structure (see FIG. 2) which surrounds the jacket end 5 of the optical fiber cord 1 over the entire circumference, and has a plurality of saw-tooth like ridge 20 formed on the inner circumferential surface (FIG. 3) so that they can bite into the jacket 4 and hitch the jacket end 5 with frictional force. The hitching section 16 should have, on the one hand, suitable flexibility as a whole so as to permit it to be elastically deformed by the pressing force exerted by the pressing section 18 of the fixing member 14, and should have, on the other hand, sufficient rigidity such that each ridge can bite into the jacket 4 at the sharp end.

In the illustrated embodiment, the hitching section 16 having tubular structure has an external shape of a generally rectangular parallelopiped with generally rectangle cross section, and a plurality of ridges 20 are formed in mutually corresponding positions respectively on opposing two surfaces that define the through-hole for receiving the jacket end 5. In this case, the separation of the sharp ends of the mutually opposing ridges 20 is set to be somewhat smaller than the outer diameter of the jacket 4 of the optical fiber cord 1 to be held (FIG. 3). Shape of the hitching section 16 is not limited to that in the illustrated embodiment, and the hitching section 16 may have any suitable external shape, for example, cylindrical shape, polygonal pillar shape, or the like. Also, the ridges 20 may be formed in an arrangement that permits engagement with all or a part of the outer circumference of the optical fiber cord 1.

The hitching section 16 includes a plate-like first part 22 on which the jacket end 5 is to be placed, and a second part 26 which is to be combined with the first part 22 and which has a receiving groove 24 for receiving the jacket end 5 placed on the first part 22, and a plurality of ridges 20 are formed in the receiving groove 24 of the second part 26 (see FIG. 1). The first part 22 and the second part 26 can be moved relative to each other, and by properly combining the first and the second part 22, 26, the receiving groove 24 that is open on one side of the second part 26 is closed by the first part 22 on that side so as to form a hollow tubular hitching section 16. In this configuration, by pressing the open end of the receiving groove 24 of the second part 26 laterally toward the jacket end 5 placed on the first part 22, the jacket end 5 can be received properly in the receiving groove 24, so that the operation of hitching the jacket end 5 by the tubular hitching section can be simplified.

In the illustrated embodiment, the first part 22 and the second part 26 are linked rotatably relative to each other via a linkage part 28. In this case, the first part 22 and the second part 26 together with the linkage part 28 can be integrally molded from a synthetic resin material in one unit, and can be constructed such that the first and the second parts 22, 26 can be rotated relative to each other with associated deformation of the linkage part 28. In this configuration, the structure of the hitching section 16 can be simplified, and the number of process steps for manufacturing the supporting member 12 can be reduced.

The supporting member 12 further includes a fiber guide 30 for guiding, in a centered state, the covered optical fiber 2 exposed at the end of the optical fiber cord 1, and an extension section 32 extended from the fiber guide 30 on the side opposite to the hitching section 16 (FIG. 3). The fiber guide 30 has a support groove 34 for stably supporting the covered optical fiber 2 with no deviation at a position adjacent to the jacket end 5 hitched by the hitching section 16. In the illustrated embodiment, an inner wall 36 having the support groove 34 is provided adjacent to the second part 26 of the hitching section 16, and a protrusion 38 capable of being fitted into the support groove 34 is provided adjacent to the first part 22 of the hitching section 16 (FIG. 1). By combining the first and the second parts 22, 26 properly as described above, the protrusion 38 is fitted into the support groove 34 so as to reduce the deviation of the covered optical fiber 2 on the support groove 34. The extension section 32 has a tubular structure such that it can substantially surround the covered optical fiber 2 guided by the fiber guide 30 via a gap over a predetermined length. Preferably, the entire supporting member 12 including the hitching section 16, the fiber guide 30 and the extension section 32 is integrally molded, for example by injection molding process, in one unit from a suitable synthetic resin material.

The pressing section 18 of the fixing member 14 has a structure such that it can engage with the outer surface of the hitching section 16 of the supporting member 12 and compress the hitching section 16 having a tubular structure toward the center axis. In particular, the pressing section 18 is constructed such that it can compress the flexible hitching section 16 by the pressing force generated in dependence on the dimensional difference of the outer dimensions between the hitching section 16 and the pressing section 18. The pressing section 18 has sufficient rigidity such that it can deform the hitching section elastically without substantially deforming itself.

The pressing section 18 also includes a pair of arm portions 40 for sandwiching the hitching section 16 of the supporting member 12 under pressure (FIG. 1). The arm portions 40 are integrally linked at respective one ends to the outer periphery (one side of rectangular outline) of a base 42 in the shape of generally rectangular plate, and are extended in parallel to each other in a direction generally perpendicular to the base 42. Both arm portions 40 receive the hitching section 16 of the supporting member 12 into the void space formed therebetween, and engage at respective opposing sides 40a with sides 16a of the hitching section 16 (FIG. 5). Here, the supporting member 12 and the fixing member 14 are both constructed such that, in undeformed normal state, the separation d1 of the two arm portions 40 is slightly smaller than the thickness d2 of the hitching section 16 (FIG. 5). With such configuration, the pressing force that is determined by the dimensional difference between d1 and d2 can be easily and properly exerted to the hitching section 16 by the two arm portions 40.

The fixing member 14 further includes a pair of auxiliary arms 44 disposed in opposition to the pair of arm portions 40 (only one auxiliary arm 44 is shown in FIG. 1). These auxiliary arms 44 are integrally linked at respective one ends to a site of outer periphery of the base 42 (one side of the rectangular outline) in opposition to the linkage site for arm portions 40, and are extended in parallel to each other in a direction generally perpendicular to the base 42. Under the dimensional relation and interaction similar to the dimensional relation and interaction of the arm portions 40 and the hitching section 16 as described above, the two auxiliary arms 44 receive the tubular extension 32 of the supporting member 12 in the void space formed therebetween, and engage at respective opposing sides with two sides of the extension 32.

The fixing member 14 further includes a pair of guide pieces 46 at positions different from those of both arm portions 40 and both auxiliary arms 44 (see FIG. 1). These guide pieces 46 are integrally linked at sites (two opposing sides of the rectangular outline) that are intermediate between the linkage sites of the arm portions 40 and the auxiliary arms 44, and are extended in parallel to each other in a direction generally perpendicular to the base 42. Action of the guide pieces 46 will be described later. Preferably, the entire fixing member 14 including the pressing section 18 (two arm portions 40), a base 42, two auxiliary arms 44 and two guide pieces 46 is integrally formed in one unit from suitable metal plate material, for example by press operation.

In the holding device 10 having the configuration as described above, the optical fiber cord 1 can be fixedly held in two step operation. That is, in the first step, the jacket end 5 of the optical fiber cord 1 is hitched by the hitching section 16 of the supporting member 12, and in the second step, the hitching section 16 having the jacket end 5 hitched thereon is deformed by the pressing force exerted by the pressing section 18 of the fixing member 14 so as to bring the hitching section 18 and the jacket end 5 into close contact with each other. Since press-calking process is not employed in this holding operation, a dedicated special calking tool is not required, and the number of parts can be reduced as compared to a conventional holding device employing the press-calking process. In the holding device 10, in the first step, in which the jacket end 5 is hitched by the hitching section 16 of the supporting member 12 with holding strength required to a temporary holding (wherein the jacket end 5 may be forcibly displaced by an external force such as a tensile force), the operation can be manually accomplished with relatively weak force by an operator. In the second step, in which the pressing section 18 of the fixing member 14 engages with the outer surface of the hitching section 16 of the supporting member 12 and the flexible hitching section 16 in tubular form is compressed toward the center axis, the operation can be accomplished as a relatively simple non-manual operation without requiring the force of an operator, and the jacket end 5 can be securely fixed to the hitching section 16.

Thus, with the holding device 10, the number of parts can be reduced, and the optical fiber cord 1 can be held easily in manual operation without using a special dedicated tool such as a calking tool. In the holding method for holding the optical fiber cord 1 carried out by using the holding device 10, the number of process steps can be reduced, and the optical fiber cord 1 can be easily held in manual operation without using a special dedicated tool such as a calking tool.

In particular, in the illustrated configuration in which the hitching section 16 of the supporting member 12 includes the first part 22 and the second part 26, the jacket end 5 can be easily and properly received in the receiving groove 24 of the second part 26 as described above, so that the operation in the above-described first step requires no skill on the side of an operator. In this connection, it is not necessary for the operator to directly touch the jacket end 5, but the jacket end 5 can be received in the receiving groove 24 by pressing the first part 22 and the second part 26 to each other, so that the damage of the covered optical fiber 2 located at the jacket end 5 can be substantially eliminated. Also, in the illustrated configuration in which the pressing section 18 of the fixing member 14 has a pair of arm portions 40 extended from the base 42, since the hitching section 16 can be received in the void space between both arm portions and specified pressing force can be thereby easily and properly exerted to the hitching section 16 as described above, the operation in the above-described second step requires no skill of an operator, and the labor of the operator can be substantially reduced by using a general purpose manual tool such as a plier as required.

As shown in FIG. 4, the holding device 10 may further include a housing 48 for containing the supporting member 12. The housing 48 has a cavity 50 that is capable of containing generally entire supporting member 12 including the hitching section 16, the fiber guide 30 and the extension 32. The cavity 50 is a through-hole penetrating the housing 48 in one direction, and is defined by four side walls 48a-48d of the housing 48 having an outer shape of a generally rectangular parallelepiped. The supporting member 12 supporting the jacket end 5 of the optical fiber cord 1 is inserted into the cavity 50 of the housing 48 beginning from the distal end of the exposed covered optical fiber 2, and is moved in axial direction so that extension 32 and the hitching section 16 are successively received by the cavity 50.

The housing 48 includes, on one side wall 48a, a pair of slits 52, 54 which are formed penetratingly in the thickness direction of the wall, respectively adjacent to openings at both ends of the cavity 50. The housing 48 further includes, on each of the two side walls 48b, 48d, a guide groove 56 recessively provided on the outer surface at a position corresponding to an intermediate point between the two slits 52, 54. The fixing member 14 is assembled into the housing 48 so as to permit relative displacement by inserting the two arm portions 40 and the two auxiliary arms 44 respectively into the pair of slits 52, 54 of the housing 48 and by sliding and fitting the two guide pieces 46 into the pair of guide grooves 56 of the housing 48. The side wall 48b of the housing 48 is divided into two so as to partially open the cavity 50. This configuration is not necessarily required.

The operation of holding the optical fiber cord 1 in the holding device 10 having the above configuration will be described below with reference to FIG. 5. First, prior to the second step as described above, the fixing member 14 is arranged at a preparatory position on the housing 48 such that the two arm portions 40 (pressing section 18) and the two auxiliary arms 44 do not project into the cavity 50 (FIG. 4, FIG. 5(a)). In this state, after the completion of the operation in the first step as described above, the supporting member 12 supporting the optical fiber cord 1 is inserted into the cavity 50 of the housing 48 beginning from the distal end of the exposed covered optical fiber 2, and is moved in axial direction so that extension 32 and the hitching section 16 are successively fitted into the cavity 50 (FIG. 5(a)).

Next, the base 42 of the fixing member 14 is pushed with a force F in the direction toward the housing 48 so as to move the fixing member 14 under mutual guiding action of two guide pieces 46 and two guide grooves 56 to thereby project the two arm portions 40 and the two auxiliary arms 44 into the cavity 50 (only the arm portions 40 are shown in FIG. 5). The two arm portions 40 (the pressing section 18) and the two auxiliary arms 44 thus engage with the supporting member 12 contained in the cavity 50 of the housing 48 (FIG. 5(b)). At this time, the two arm portions 40 slide and engage while exerting pressing force determined by the dimensional difference between the separation d1 and the thickness d2 (FIG. 5(a)) to the two sides 16a of the hitching section 16 with the respective opposing sides 40a. As a result, the hitching section 16 is elastically deformed in compression under the pressing force, and the jacket end 5 of the optical fiber cord 1 (especially the jacket 4) that is received and hitched in the receiving groove 24 is elastically deformed in accordance with the deformation of the hitching section 16. At the same time, the two auxiliary arms 44 similarly slide and engage while exerting a pressing force to the two sides of the extension 32 of the supporting member 12 with respective opposing sides.

By continuing to push the fixing member 14 toward the housing 48, the hitching section 16 of the supporting member 12 is completely received in the void space between the pair of arm portions 40 of the pressing section 18, and sufficient pressing force is exerted from the two arm portions 40 to the hitching section 16 toward the center axis (FIG. 5(c)). As a result, the hitching section 16 is uniformly compressed under the pressing force, and are elastically deformed, and the jacket end 5 of the optical fiber cord 1 (especially the jacket 4) is further elastically deformed so as to conform to the shape of the receiving groove 24 so that gap between the jacket end 5 and the receiving groove 24 is substantially eliminated. This state of full compression is automatically maintained by the frictional force between the pressing section 18 and the hitching section 16 and by the pressing force of the pressing section 18 in cooperation with the elastic restoring force of the hitching section 16.

In this way, with the pressing force of the pressing section 18, the fixing member 14 brings the hitching section 16 of the supporting member 12 into close contact with the jacket end 5, and securely fixes the optical fiber cord 1 to the supporting member 12. Further, with the two arm portions 40 engaging with the hitching section 16 under the pressing force and with the two auxiliary arms 44 engaging with the extension 32 under the pressing force, the fixing member 14 securely and stably fixes the supporting member 12 to the housing 48. In the illustrated embodiment, in order to temporarily hold the fixing member 14 on the housing 48 at the preparatory position (FIG. 5(a)) and at the fully compressed position (FIG. 5(c)), respectively, a hitching hole 58 is provided near the distal end of each of the guide pieces 46 and a pair of hitching claws 60 are provided on the two guide grooves 56 of the housing 48 (FIG. 4).

With the holding device 10 having the above configuration, when carrying out the second step of the operation for holding the optical fiber cord 1 (that is, the step in which the hitching section 16 of the supporting member 12 having the jacket end 5 hitched thereon is deformed by the pressing force exerted by the pressing section 18 of the fixing member 14), the fixing member 14 can be accurately moved in translation under the guiding action provided by the housing 48 relative to the supporting member 12 that is fixedly supported in a specified attitude in the cavity 50 of the housing 48, such that the pressing section 18 may easily engage with the hitching section 16 in proper relative position. As a result, the force F of an operator can be effectively applied to the fixing member 14 in order to accurately transfer the required pressing force from the pressing section 18 to the hitching section 16, and thus, the hitching section 16 and the jacket end 5 can be brought into close contact with each other stably with high reproducibility. Therefore, the optical fiber cord 1 can be easily and accurately held without requiring the force or the skill of an operator. In the configuration shown in FIG. 5, the supporting member 12 and the fixing member 14 has a positional correlation at the time of a mutual engagement, in which the extending direction of the ridges 20 (FIG. 1) formed in the receiving groove 24 of the hitching section 16 is generally orthogonal to the extending direction of the arm portions 40 of the pressing section 18. However, even if the positional correlation of the supporting member 12 and the fixing member 14 at the time of a mutual engagement is defined such that the ridges 20 (FIG. 1) extend generally parallel to the arm portions 40, the fixing member 14 can also make the hitching section 16 closely contact with the jacket end 5, so as to securely fixes the optical fiber cord 1 to the supporting member 12.

As shown in FIG. 6 and FIG. 7, the supporting member 12 of the holding device 10 may include a guiding section 64 having an opening 62 through which the optical fiber cord 1 can be inserted, adjacent to the hitching section 16. The opening 62 of the guiding section 64 has an inner diameter slightly larger than the outer diameter of the jacket end 5 of the optical fiber cord 1. With such configuration, when carrying out the first step of the operation for holding the optical fiber cord 1 as described above (that is, the step in which the jacket end 5 is hitched by the hitching section 16 of the supporting member 12), the distal end portion of the optical fiber cord 1 with the jacket 4 stripped off over a predetermined length to expose the covered optical fiber 2 and the tension member 3 (FIG. 6) is inserted into the opening 62 of the guiding section 64. Exposed portion of the tension member 3 not restrained around the covered optical fiber 2 collides with the guiding section 64 and is automatically folded back over the outer surface of the jacket 4. Therefore, the jacket end 5 is automatically formed and disposed in the hitching section 16 by inserting the distal end portion of the optical fiber cord 1 through the opening 62 until the entire exposed portion of the tension member 3 has just passed through the guiding section 64 (FIG. 7). With such configuration, the above-described first step of the holding operation can be simply and quickly carried out.

In the above configuration, the guiding section 64 of the supporting member 12 may include a strain relief boot 66 for the optical fiber cord 1 supported by the supporting member 12. In the illustrated embodiment, the entire guiding section 64 has the shape of a strain relief boot 66 and is formed integrally to the hitching section 16 with the inner lumen of the strain relief boot 66 constituting the opening 62. The strain relief boot 66 is a tubular element having sufficient flexibility, and receives the region of the optical fiber cord 1 adjacent to the supporting member 12 so as to relax the internal stress generated by bending or the like of the optical fiber cord 1. With such configuration, a strain relief boot as a separate part is not required, so that the number of parts and the number of process steps of assembling of the holding device 10 can be reduced. Moreover, for example in a field assembling process, it is possible to prevent forgetting to mount the separate strain relief boot onto the optical fiber cord 1 before the optical fiber cord 1 is held by the holding device.

The guiding section 64 of the supporting member 12 may be a constituent different from the strain relief boot 66. In this case, the guiding section 64 having various shapes such as O-ring shape, C-ring shape, etc. which permit the exposed portion of the tension member 3 to be automatically folded back over the outer surface of the jacket 4 can be formed adjacent to the hitching section 16.

FIG. 8 is a view showing an optical fiber connecting apparatus 70 according to an embodiment of the present invention including the holding device 10 as described above.

The optical fiber connecting apparatus 70 has the configuration of an optical connector including a ferrule (not shown) and a splice section 72 arranged on the front end side of a main body 74. In the optical fiber connecting apparatus 70, a built-in bare optical fiber of a specified length fixed and supported in advance in the ferrule and a bare optical fiber (obtained by stripping off a covering of the covered optical fiber) of the optical fiber cord 1 introduced from the rear end side of the main body 74 are securely fixed and interconnected with respective ends abutted to each other by the splice section 72. This configuration is known as so-called a field assembling type optical connector.

The optical fiber connecting apparatus 70 is constructed such that the housing 48 of the holding device 10 is attached to the rear end of the main body 74. The fixing member 14 has been assembled to the housing 48 in advance as described above. The optical fiber cord 1 with the jacket end 5 (FIG. 1) supported by the supporting member 12 has its bare optical fiber exposed by removing the coating from the covered optical fiber over a distal end region of a predetermined length. In this state, the supporting member 12 is fitted into the cavity 50 of the housing 48, and by handling the splice section, the bare optical fiber of the optical fiber cord 1 is connected to the built-in bare optical fiber in the ferrule. Thereafter, the fixing member 14 engages with the supporting member 12 to fixedly hold the optical fiber cord 1 with the holding device 10.

Since the optical fiber connecting apparatus 70 having the configuration as described above includes the holding device 10, the number of parts can be reduced, and the optical fiber cord 1 can be easily held in the holding device 10 in manual operation without using a dedicated special tool such as a calking tool. Therefore, it is very suitable for a field assembling. The optical fiber connecting apparatus 70 is not limited to the illustrated optical connector, and may utilize any suitable optical connector having different configuration. Various other constructions can be employed such as a splice box provided in an optical fiber relay point. In any configuration, the holding device 10 can be provided at the interface between the optical fiber connecting apparatus and the optical fiber cord.

### DESCRIPTION OF REFERENCE NUMERALS

1 optical fiber cord

5 jacket end

10 holding device

12 supporting member

14 fixing member

16 hitching section

18 pressing section

22 first part

24 receiving groove

26 second part

30 fiber guide

32 extension

40 arm portion

48 housing

50 cavity

62 opening

64 guiding section

66 strain relief boot

70 optical fiber connecting apparatus

1. A holding device for fixedly holding an optical fiber cord including a covered optical fiber and a tension member, both contained in a jacket, characterized in that said holding device comprises:
a supporting member supporting the optical fiber cord; and
a fixing member fixing the optical fiber cord relative to said supporting member;
wherein said supporting member includes a hitching section hitching a jacket end configured by turning back an exposed tension member onto an outer surface of the jacket, in a manner as to prevent the optical fiber cord from falling off from said supporting member due to at least a weight of the optical fiber cord; and
wherein said fixing member includes a pressing section acting to deform said hitching section hitching said jacket end by a pressing force to make said hitching section closely contact with said jacket end.

2. A holding device as set forth in claim 1, wherein said fixing member generates said pressing force dependently on a dimensional difference between said hitching section and said pressing section.

3. A holding device as set forth in claim 1, wherein said hitching section of said supporting member includes a first part on which said jacket end of the optical fiber cord is placed and a second part adapted to be assembled with said first part, said second part including a receiving groove receiving said jacket end placed on said first part and hitching said jacket end by frictional force.

4. A holding device as set forth in claim 3, wherein said supporting member includes a guiding section adjacent to said hitching section, said guiding section having an opening through which the optical fiber cord can pass, said jacket end being automatically formed and disposed on said hitching section by inserting a distal end region of the optical fiber cord, of which the covered optical fiber and the tension member are exposed, through said opening of said guiding section.

5. A holding device as set forth in claim 4, wherein said guiding section of said supporting member includes a strain relief boot provided for the optical fiber cord supported by said supporting member.

6. A holding device as set forth in claim 1, wherein said pressing section of said fixing member includes a pair of arm portions for anchoring said hitching section of said supporting member between said arm portions under pressure.

7. A holding device as set forth in claim 1, further comprising a housing for containing said supporting member; wherein said fixing member is incorporated in said housing in a relatively movable manner and operates, by engaging said pressing section with said hitching section of said supporting member contained in said housing, to fix the optical fiber cord to said supporting member and also fix said supporting member said housing.

8. An optical fiber connecting apparatus comprising a holding device as set forth in claim 1.

9. A method for fixedly holding an optical fiber cord including a covered optical fiber and a tension member, both contained in a jacket, characterized in that said method comprises:
providing a supporting member supporting the optical fiber cord;
providing a fixing member fixing the optical fiber cord relative to said supporting member;
supporting and hitching a jacket end, configured by turning back an exposed tension member onto an outer surface of the jacket, on said supporting member, in a manner as to prevent the optical fiber cord from falling off from said supporting member due to at least a weight of the optical fiber cord; and
engaging said fixing member with said supporting member supporting said jacket end and deforming said supporting member by a pressing force applied by said fixing member so as to make said supporting member closely contact with said jacket end.
